(19) United States
(12) Patent Application Publication
(10) Pub. No.: US 2007/0057578 A1
(43) Pub. Date: Mar. 15, 2007

(54) Noise suppressing circuit

(75) Inventor: Masaru Wasaki, (US)

Correspondence Address: OLIFF & BERRIDGE, PLC, P.O. BOX 19928, ALEXANDRIA, VA, 22320, US

(73) Assignee: TDK Corporation, Tokyo (JP)

(21) Appl. No.: 10/557,995

(22) PCT Filed: May 14, 2004
(86) PCT No.: PCT/JP04/06866

§ 371 Date: Nov. 22, 2005

(30) Foreign Application Priority Data
May 29, 2003 (JP) 2003-151766

(51) Int. Cl. H04B 3/00

(52) U.S. Cl. 307/89

(57) ABSTRACT

A noise suppressing circuit comprises: a winding (11a) inserted to a conductor line (3) at a first point (P11); a winding (11b) coupled to the winding (11a); an injection signal transmission path (19); and an inductance element (13). The injection signal transmission path (19) has an end connected to the conductor line (3) at a second point (P12) and the other end connected to a conductor line (4). The winding (11b) is inserted somewhere along the injection signal transmission path (19). The injection signal transmission path (19) transmits an injection signal that is generated based on a signal corresponding to noise detected on the conductor line (3) and that is injected to the conductor line (3) to suppress the noise. The inductance element (13) is inserted to the conductor line (3) at a point between the point (P11) and the point (P12). The number of turns of the winding (11b) is greater than that of the winding (11a).

### TECHNICAL FIELD

The present invention relates to a noise suppressing circuit for suppressing noise propagating through a conductor line.

### BACKGROUND ART

Power electronics apparatuses such as a switching power supply, an inverter and a lighting circuit of a lighting fixture incorporate a power transformer circuit for transforming power. The power transformer circuit incorporates a switching circuit for transforming a direct current to an alternating current having rectangular waves. Consequently, the power transformer circuit develops a ripple voltage having a frequency equal to the switching frequency of the switching circuit, and noise resulting from the switching operation of the switching circuit. Such a ripple voltage and noise affect other apparatuses. It is therefore required to provide a means for reducing the ripple voltage and noise between the power transformer circuit and the other apparatuses or lines.

LC filters, that is, filters each incorporating an inductance element (an inductor) and a capacitor, are often used as such a means for reducing the ripple voltage and noise. The LC filters include a T filter and a π filter, in addition to the one incorporating an inductance element and a capacitor. A typical noise filter for suppressing electromagnetic interference (EMI) is a type of LC filters, too. A typical EMI filter is made up of a combination of discrete elements such as a common mode choke coil, a normal mode choke coil, an X capacitor, and a Y capacitor.

Recently, power-line communications have been developed as a potential communications technique used for creating communications networks in homes. For the power-line communications, high-frequency signals are superimposed on a power line to perform communications. When the power-line communications are performed, noise emerges on the power line because of the operations of various electric and electronic apparatuses connected to the power line, which causes a reduction in quality of communications, such as an increase in error rate. It is therefore required to provide a means for reducing noise on the power line. Moreover, it is required for the power-line communications to prevent communications signals on an indoor power line from leaking to an outdoor power line. The LC filters are used as a means for reducing noise on the power line and for preventing communications signals on the indoor power line from leaking to the outdoor power line as thus described, too.

There are two types of noise propagating along two conductor lines: one is normal mode noise that creates a potential difference between the two conductor lines, while the other is common mode noise that propagates along the two conductor lines with identical phases.

Japanese Published Patent Application 9-102723 discloses a line filter using a transformer. The line filter comprises the transformer and a filter circuit. The transformer incorporates a secondary winding inserted to one of two conductor lines for transmitting power from an alternating power supply to a load. The filter circuit has two inputs connected to ends of the alternating power supply, and two outputs connected to ends of a primary winding of the transformer. In the line filter, the filter circuit extracts noise components from the supply voltage and supplies the noise components to the primary winding of the transformer, so that the noise components are subtracted from the supply voltage on the conductor line to which the secondary winding of the transformer is inserted. This line filter reduces normal mode noise.

The conventional LC filters have a problem that, since the filters have a specific resonant frequency determined by the inductance and the capacitance, a desired amount of attenuation is obtained only within a narrow frequency range.

It is required for a filter inserted to a conductor line for power transfer that a desired characteristic is obtained while a current for power transfer flows and that a measure is taken against an increase in temperature. Therefore, such a filter has a problem that the inductance element is increased in size to implement a desired characteristic.

According to the line filter disclosed in Japanese Published Patent Application 9-102723, it is theoretically possible to remove noise components completely as long as the impedance of the filter circuit is zero and the coupling coefficient of the transformer is 1. In practice, however, it is impossible that the impedance of the filter circuit is zero. Furthermore, the impedance changes in response to the frequency. If the filter circuit is formed using a capacitor, in particular, the capacitor and the primary winding of the transformer make up a series resonant circuit. Hence, the impedance of a signal path including the capacitor and the primary winding of the transformer is reduced only in a narrow frequency range around the resonant frequency of the series resonant circuit. As a result, this line filter is capable of removing noise components only in a narrow frequency range. In addition, the coupling coefficient of the transformer is smaller than 1 in practice. Therefore, noise components supplied to the primary winding of the transformer are not completely subtracted from the supply voltage. Because of these facts, the line filter actually fabricated has a problem that it is impossible to effectively reject noise components in a wide frequency range.

In many countries, various restrictions are placed on conducted noise, that is, noise emerging from an electronic apparatus and emitted outside through an alternate current power line. According to the standard of the International Special Committee on Radio Interference (CISPR), for example, the standard is imposed on conducted noise in a frequency range of 150 kHz to 30 MHz. To reduce noise in such a wide frequency range, a problem that will now be described occurs with regard to noise in a low frequency range of 1 MHz and lower, in particular. In a low frequency range of 1 MHz and lower, the absolute value of impedance of a coil is expressed as 2 πfL where L is the inductance of the coil and ‘f’ is the frequency. Therefore, a filter including a coil having a high inductance is typically required for reducing noise in a low frequency range of 1 MHz and lower. As a result, the filter is increased in size.

### DISCLOSURE OF THE INVENTION

It is an object of the invention to provide a noise suppressing circuit capable of suppressing noise in a wide frequency range and achieving a reduction in size.

A first noise suppressing circuit of the invention is a circuit for suppressing noise propagating through a conductor line and comprises: a first winding inserted to the conductor line at a specific first point; a second winding coupled to the first winding; an injection signal transmission path that connects the second winding to a second point on the conductor line different from the first point through a path different from the conductor line and that transmits an injection signal generated based on a signal corresponding to noise detected on the conductor line and injected to the conductor line to suppress the noise; and a capacitor inserted to the injection signal transmission path and allowing the injection signal to pass. The number of turns of the second winding is greater than the number of turns of the first winding.

According to the first noise suppressing circuit of the invention, a signal corresponding to noise is detected on the conductor line at one of the first and second points, and an injection signal is generated based on the signal detected. The injection signal is injected to the conductor line at the other one of the first and second points through the injection signal transmission path. Since a series resonant circuit is formed of the second winding and the capacitor in the noise suppressing circuit, there exists a frequency at which attenuation is maximum in a frequency characteristic of attenuation of noise. Since the number of turns of the second winding is greater that that of the first winding in the noise suppressing circuit, the frequency at which attenuation is maximum is shifted to a lower frequency, compared with a case in which the number of turns of the second winding is equal to that of the first winding.

In the first noise suppressing circuit of the invention, a value obtained by dividing the number of turns of the second winding by the number of turns of the first winding may be greater than 1 and smaller than or equal to 2.0.

A second noise suppressing circuit of the invention is a circuit for suppressing noise propagating through a conductor line and comprises: a first winding inserted to the conductor line at a specific first point; a second winding coupled to the first winding; an injection signal transmission path that connects the second winding to a second point on the conductor line different from the first point through a path different from the conductor line and that transmits an injection signal generated based on a signal corresponding to noise detected on the conductor line and injected to the conductor line to suppress the noise; a first capacitor inserted to the injection signal transmission path and allowing the injection signal to pass, and a second capacitor provided in parallel to the second winding.

According to the second noise suppressing circuit of the invention, a signal corresponding to noise is detected on the conductor line at one of the first and second points, and an injection signal is generated based on the signal detected. The injection signal is injected to the conductor line at the other one of the first and second points through the injection signal transmission path. Since a series resonant circuit is formed of the second winding and the first capacitor in the noise suppressing circuit, there exists a frequency at which attenuation is maximum in a frequency characteristic of attenuation of noise. Since the noise suppressing circuit comprises the second capacitor provided in parallel to the second winding, the frequency at which attenuation is maximum is shifted to a lower frequency, compared with a case in which the second capacitor is not provided.

In the second noise suppressing circuit of the invention, a value obtained by dividing the capacitance of the second capacitor by the capacitance of the first capacitor may fall within a range of 0.001 to 0.5 inclusive.

The first or second noise suppressing circuit of the invention may further comprise a peak value reducing section that is inserted to the conductor line at a point between the first and second points and that reduces a peak value of the noise propagating through the conductor line.

The first or second noise suppressing circuit of the invention may be a circuit for suppressing normal mode noise that is transmitted through two conductor lines and that creates a potential difference between the two conductor lines. In this case, the first winding may be inserted to at least one of the conductor lines.

The first or second noise suppressing circuit of the invention may be a circuit for suppressing common mode noise propagating through two conductor lines with identical phases. In this case, the noise suppressing circuit may further comprise another first winding and another capacitor (another first capacitor) the two first windings may be inserted to the two conductor lines, respectively, to suppress common mode noise in cooperation with each other, the second winding may be coupled to the two first windings, the injection signal transmission path may be branched and connected to the two conductor lines, and the two capacitors (first capacitors) may be inserted to the injection signal transmission path at respective points between a branch point of the injection signal transmission path and the respective conductor lines.

For the first or second noise suppressing circuit of the invention, the frequency at which attenuation is maximum may be 1 MHz or lower.

Other and further objects, features and advantages of the invention will appear more fully from the following description.

### BRIEF DESCRIPTION OF THE DRAWINGS

FIG. 1 is a schematic diagram illustrating a configuration of a noise suppressing circuit of a first embodiment of the invention.

FIG. 2 is a block diagram illustrating a basic configuration of a cancellation-type noise suppressing circuit.

FIG. 3 is a schematic diagram for illustrating an operation of the cancellation-type noise suppressing circuit of FIG. 1.

FIG. 4 is a schematic diagram illustrating a simulation circuit assumed in a simulation for showing an effect of the noise suppressing circuit of the first embodiment of the invention.

FIG. 5 is a plot showing frequency characteristics of attenuation of normal mode noise of the simulation circuit of FIG. 4.

FIG. 6 is a schematic diagram illustrating a configuration of a noise suppressing circuit of a second embodiment of the invention.

FIG. 7 is a schematic diagram illustrating a simulation circuit assumed in a simulation for showing an effect of the noise suppressing circuit of the second embodiment of the invention.

FIG. 8 is a plot showing frequency characteristics of attenuation of normal mode noise of the simulation circuit of FIG. 7.

FIG. 9 is a schematic diagram illustrating a configuration of a noise suppressing circuit of a third embodiment of the invention.

FIG. 10 is a schematic diagram illustrating a configuration of a noise suppressing circuit of a fourth embodiment of the invention.

FIG. 11 is a schematic diagram illustrating a simulation circuit assumed in a simulation for showing an effect of the noise suppressing circuit of the third embodiment of the invention.

FIG. 12 is a schematic diagram illustrating a simulation circuit assumed in a simulation for showing an effect of the noise suppressing circuit of the fourth embodiment of the invention.

FIG. 13 is a plot showing frequency characteristics of attenuation of common mode noise of the simulation circuits of FIG. 11 and FIG. 12.

### BEST MODE FOR CARRYING OUT THE INVENTION

Preferred embodiments of the invention will now be described in detail with reference to the accompanying drawings. A noise suppressing technique employed in the embodiments of the invention will now be described. A cancellation-type noise suppressing circuit is used in each of the embodiments. Reference is made to FIG. 2 to describe a basic configuration and an operation of the cancellation-type noise suppressing circuit.

As shown in FIG. 2, the cancellation-type noise suppressing circuit comprises: two detection/injection sections 102 and 103 connected to a conductor line 101 at different points A and B; an injection signal transmission path 104 that connects the two detection/injection sections 102 and 103 to each other through a path different from the conductor line 101; and a peak value reducing section 105 provided between the detection/injection sections 102 and 103 on the conductor line 101.

Each of the detection/injection sections 102 and 103 performs detection of a signal corresponding to noise or injection of an injection signal for suppressing noise. The injection signal transmission path 104 transmits injection signals. The peak value reducing section 105 reduces a peak value of noise. The detection/injection section 102 incorporates an inductance element, for example. The injection signal transmission path 104 includes, for example, a high-pass filter comprising a capacitor. The peak value reducing section 105 incorporates an impedance element such as an inductance element.

In the cancellation-type noise suppressing circuit of FIG. 2, if a noise source is located at a point closer to the point B than the point A except a point located somewhere between the points A and B, the detection/injection section 103 detects a signal corresponding to noise on the conductor line 101 at the point B, and generates an injection signal to be injected to the conductor line 101, based on the signal detected, to suppress the noise on the conductor line 101. This injection signal is sent to the detection/injection section 102 through the injection signal transmission path 104. The detection/injection section 102 injects the injection signal to the conductor line 101 such that the signal has a phase opposite to that of the noise on the conductor line 101. As a result, the noise on the conductor line 101 is cancelled out by the injection signal, and noise is suppressed along a portion of the conductor line 101 from the point A onward along the direction of travel of the noise. In the present patent application, noise includes unwanted signals, too.

In the cancellation-type noise suppressing circuit of FIG. 2, if a noise source is located at a point closer to the point A than the point B except a point located somewhere between the points A and B, the detection/injection section 102 detects a signal corresponding to noise on the conductor line 101 at the point A, and generates an injection signal to be injected to the conductor line 101, based on the signal detected, to suppress the noise on the conductor line 101. This injection signal is sent to the detection/injection section 103 through the injection signal transmission path 104. The detection/injection section 103 injects the injection signal to the conductor line 101 such that the signal has a phase opposite to that of the noise on the conductor line 101. As a result, the noise on the conductor line 101 is cancelled out by the injection signal, and noise is suppressed along a portion of the conductor line 101 from the point B onward along the direction of travel of the noise.

The peak value reducing section 105 reduces a peak value of noise passing through the conductor line 101 between the points A and B. As a result, the difference is reduced between the peak value of the noise propagating through the conductor line 101 and the peak value of the injection signal injected to the conductor line 101 through the injection signal transmission path 104.

According to the cancellation-type noise suppressing circuit, it is possible to effectively suppress noise in a wide frequency range.

The cancellation-type noise suppressing circuit may be designed without the peak value reducing section 105. However, if the noise suppressing circuit includes the peak value reducing section 105, it is possible to suppress noise in a wider frequency range as compared with the case where the noise suppressing circuit does not include the peak value reducing section 105.

The configuration of the cancellation-type noise suppressing circuit includes one for suppressing normal mode noise and one for suppressing common mode noise, which will be described in detail later. The configuration for suppressing normal mode noise is employed in the first and second embodiments while the configuration for suppressing common mode noise is employed in the third and fourth embodiments.

### FIRST EMBODIMENT

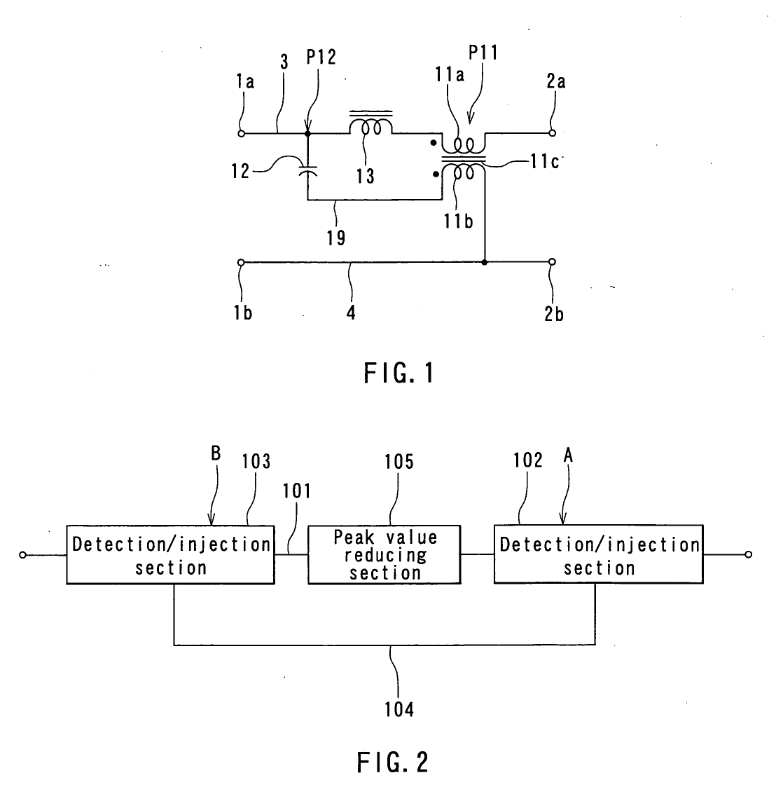

The noise suppressing circuit of the first embodiment of the invention will now be described. The noise suppressing circuit of the embodiment is a circuit for suppressing normal mode noise that is transmitted through two conductor lines and that creates a potential difference between these conductor lines. FIG. 1 is a schematic diagram illustrating a configuration of the noise suppressing circuit of the embodiment. The noise suppressing circuit comprises: a pair of terminals 1a and 1b; another pair of terminals 2a and 2b; a conductor line 3 connecting the terminal 1a to the terminal 2a; and a conductor line 4 connecting the terminal 1b to the terminal 2b. The noise suppressing circuit further comprises: a winding 11a inserted to the conductor line 3 at a specific first point P11; a magnetic core 11c; and a winding 11b coupled to the winding 11a through the core 11c. The windings 11a and 11b are both wound around the core 11c.

The noise suppressing circuit further comprises an injection signal transmission path 19. An end of the injection signal transmission path 19 is connected to the conductor line 3 at a point different from the first point P11, that is, at a second point P12 between the winding 11a and the terminal 1a. The other end of the injection signal transmission path 19 is connected to the conductor line 4. The winding 11b is inserted somewhere along the injection signal transmission path 19. Therefore, the injection signal transmission path 19 connects the winding 11b to the second point P12 on the conductor line 3 through a path different from the conductor line 3. The injection signal transmission path 19 transmits injection signals, which will be described in detail later. The injection signals are generated based on signals corresponding to normal mode noise detected on the conductor line 3, and are injected to the conductor line 3.

The noise suppressing circuit further comprises a capacitor 12 inserted to the injection signal transmission path 19. The capacitor 12 is located between the winding 11b and the node between the injection signal transmission path 19 and the conductor line 3. Alternatively, the capacitor 12 may be located between the winding 11b and the node between the injection signal transmission path 19 and the conductor line 4. The capacitor 12 functions as a high-pass filter that allows signals at frequencies equal to or higher than a specific value to pass. The capacitor 12 thereby selectively allows injection signals to pass.

The noise suppressing circuit further comprises an inductance element 13 inserted to the conductor line 3 at a point between the points P11 and P12.

In the first embodiment, the number of turns of the winding 11b is greater than that of the winding 11a. The reason will be described in detail later.

In the noise suppressing circuit of FIG. 1, the windings 11a and 11b and the core 11c correspond to the detection/injection section 102 of FIG. 2. The winding 11a corresponds to the first winding of the invention. The winding 11b corresponds to the second winding of the invention. The node between the injection signal transmission path 19 and the conductor line 3 forms the detection/injection section 103 of FIG. 2. The transmission path 19 corresponds to the transmission path 104 of FIG. 2. The inductance element 13 corresponds to the peak value reducing section 105 of FIG. 2.

The operation of the noise suppressing circuit of FIG. 1 will now be described. First, a case in which a normal mode noise source is located at a point closer to the point P12 than the point P11 except a point between the points P11 and P12 will be described. In this case, the capacitor 12 detects a signal corresponding to normal mode noise at the point P12 on the conductor line 3. Furthermore, based on the signal detected, the capacitor 12 generates an injection signal having a phase opposite to that of the normal mode noise. The injection signal is supplied to the winding 11b through the injection signal transmission path 19. The winding 11b injects the injection signal to the conductor line 3 through the winding 11a. As a result, normal mode noise is suppressed along a portion of the conductor line 3 from the point P11 onward along the direction of travel of the normal mode noise.

Next, a case in which a noise source is located at a point closer to the point P11 than the point P12 except a point between the points P11 and P12 in the noise suppressing circuit of FIG. 1 will be described. In this case, the winding 11b detects through the winding 11a a signal corresponding to normal mode noise at the point P11 on the conductor line 3. Furthermore, an injection signal is generated based on the signal detected. The injection signal is injected through the injection signal transmission path 19 and the capacitor 12 to the point P12, such that the injection signal has a phase opposite to that of the normal mode noise on the conductor line 3. As a result, normal mode noise is suppressed along a portion of the conductor line 3 from the point P12 onward along the direction of travel of the normal mode noise. As thus described, the effect of suppressing noise of the noise suppressing circuit of FIG. 1 remains the same, regardless of the direction of travel of noise.

In the noise suppressing circuit of FIG. 1, the inductance element 13 is inserted between the points P11 and P12 on the conductor line 3. As a result, in this noise suppressing circuit, the difference is reduced between the peak value of normal mode noise propagating through the inductance element 13 and the peak value of the injection signal injected to the conductor line 3 through the injection signal transmission path 19. It is thereby possible to effectively suppress normal mode noise in a wide frequency range, according to the noise suppressing circuit.

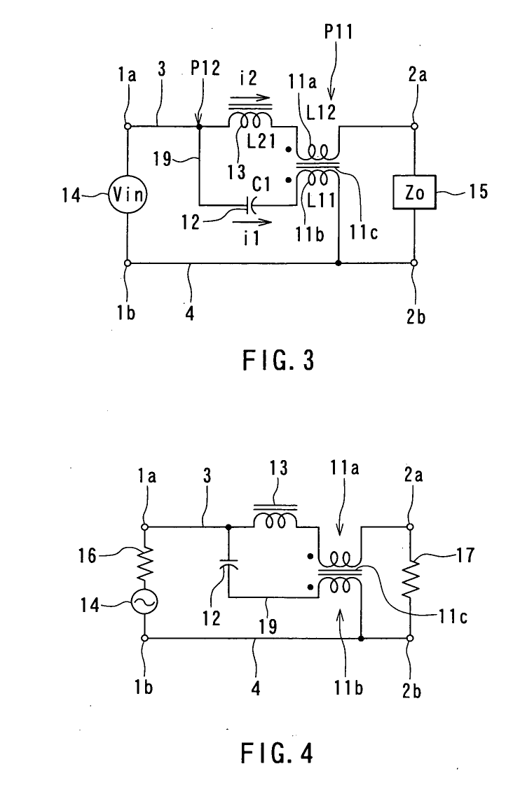

Reference is now made to FIG. 3 to describe the operation of the noise suppressing circuit of FIG. 1 in detail. FIG. 3 is a schematic diagram illustrating the noise suppressing circuit of FIG. 1 to which a normal mode noise source 14 and a load 15 are connected. The normal mode noise source 14 is connected between the terminals 1a and 1b and creates a potential difference Vin between the terminals 1a and 1b. The load 15 is connected between the terminals 2a and 2b and has an impedance Zo.

In the circuit of FIG. 3, the inductance of the winding 11b is L11, the inductance of the winding 11a is L12, the capacitance of the capacitor 12 is C1, and the inductance of the inductance element 13 is L21. The current passing through the capacitor 12 and the winding 11b is ‘i1’, and the sum of impedances on the path of the current i1 is Z1. The current passing through the inductance element 13 and the winding 11a is ‘i2’, and the sum of impedances on the path of the current i2 is Z2.

The mutual inductance between the windings 11a and 11b is M, and the coupling coefficient between the windings 11a and 11b is K. The coupling coefficient K is expressed by the following equation (1).
K=M/√(L11·L12) (1)

The above-mentioned sums Z1 and Z2 of impedances are expressed by the following equations (2) and (3), respectively, where ‘j’ indicates √(−1), and ‘ω’indicates the angular frequency of the normal mode noise.
Z1=j(ωL11−1/ωC1) (2)
Z2=Zo+jω(L12±L21) (3)

The potential difference Vin is expressed by the following equations (4) and (5).
Vin=Z1·i1+jωM·i2 (4)
Vin=Z2·i2+jωM·i1 (5)

Based on the equations (2) to (5), an equation that expresses the current ‘i2’ without including the current ‘i1’ will be obtained below. First, the following equation (6) is obtained from the equation (4).
i1=(Vin−jωM·i2)/Z1 (6)

Next, the equation (6) is substituted into the equation (5), and the following equation (7) is thereby obtained.
i2=Vin(Z1−jωM)/(Z1·Z2+ω²·M²) (7)

To suppress normal mode noise by the noise suppressing circuit of FIG. 3 means a reduction in current ‘i2’ expressed by the equation (7). According to the equation (7), the current ‘i2’ is reduced if the denominator of the right side of the equation (7) increases. Consideration will now be given to the denominator (Z1·Z2+ω²·M²) of the right side of the equation (7).

First, since Z1 is expressed by the equation (2), Z1 increases as the inductance L11 of the winding 11b increases, and Z1 increases as the capacitance C1 of the capacitor 12 increases.

Next, since Z2 is expressed by the equation (3), Z2 increases as the sum of the inductance L12 of the winding 11a and the inductance L21 of the inductance element 13 increases. Therefore, the current ‘i2’ is reduced if at least one of the inductance L12 and the inductance L21 is increased. As the equation (7) indicates, it is noted that, although it is possible to suppress normal mode noise by using the winding 11a alone, it is possible to further suppress normal mode noise by adding the inductance element 13.

Since the denominator of the right side of the equation (7) includes ω². M², the current ‘i2’ is reduced by increasing the mutual inductance M. As shown in the equation (1), the coupling coefficient K is proportional to the mutual inductance M. Therefore, if the coupling coefficient K is increased, the effect of suppressing normal mode noise by the noise suppressing circuit of FIG. 3 is enhanced. Since the mutual inductance M is included in a form of square in the denominator of the right side of the equation (7), the effect of suppressing normal mode noise greatly varies, depending on the value of coupling coefficient K.

The foregoing description similarly applies to a case in which the positional relationship between the normal mode noise source 14 and the load 15 is the reverse of that of the configuration shown in FIG. 3.

The frequency when the current ‘i2’ expressed by the equation (7) is of a minimum value will now be considered. The current ‘i2’ is of the minimum value when the numerator Vin (Z1−jωM) of the right side of the equation (7) is of a minimum value. The frequency obtained when Vin (Z1−jωM) is of the minimum value is a resonant frequency ‘fo’ of the series resonant circuit having an impedance expressed by Z−jωM. From the equations (7) and (2), the resonant frequency ‘fo’ is expressed by the equation (8) below.
fo=½π√{(L11−M)C1} (8)

The above-mentioned resonant frequency ‘fo’ is such a frequency that attenuation is of a peak (maximum) in the frequency characteristic of attenuation of noise in the noise suppressing circuit. When the mutual inductance M that the right side of the equation (8) includes is of a constant value, the resonant frequency ‘fo’ is reduced if L11 is increased. According to the embodiment, based on this principle, the number of turns of the winding 11b is made greater than that of the winding 11a to increase L11, so that attenuation of normal mode noise in the noise suppressing circuit is maximum at a frequency lower as compared with a case in which the number of turns of the winding 11b is equal to that of the winding 11a. As a result, it is possible to effectively suppress normal mode noise in a low frequency range of 1 MHz and lower, in particular.

It is preferred that the value obtained by dividing the number of turns of the winding 11b by that of the winding 11a be greater than 1 and smaller than or equal to 2.0. The reason will be described later.

Effects of the noise suppressing circuit of the embodiment will now be specifically described, using a result of a simulation shown below. FIG. 4 is a schematic diagram illustrating a simulation circuit assumed in the simulation. The simulation circuit has such a configuration that a series circuit made up of the normal mode noise source 14 and a resistor 16 is connected between the terminals 1a and 1b of the noise suppressing circuit of FIG. 1, and a resistor 17 is connected between the terminals 2a and 2b.

Values that follow were used in the simulation. The inductance of the inductance element 13 of FIG. 4 was 30 μH. The inductance of the winding 11a was 30 μH. The capacitance of the capacitor 12 was 0.33 μF. The resistance of each of the resistors 16 and 17 was 50 ohms. The inductance of the winding 11b was 30 μH, 31 μH, 33 μH, 36 μH, or 38 μH. The case in which the inductance of the winding 11b is 30 μH corresponds to the case in which the number of turns of the winding 11b is equal to that of the winding 11a. The case in which the inductance of the winding 11b is 31 μH, 33 μH, 36 μH, or 38 μH corresponds to the case in which the number of turns of the winding 11b is greater than that of the winding 11a. The inductance of the winding 11b increases as the value obtained by dividing the number of turns of the winding 11b by that of the winding 11a increases. In the simulation this value falls within a range of 1.0 to 2.0 inclusive.

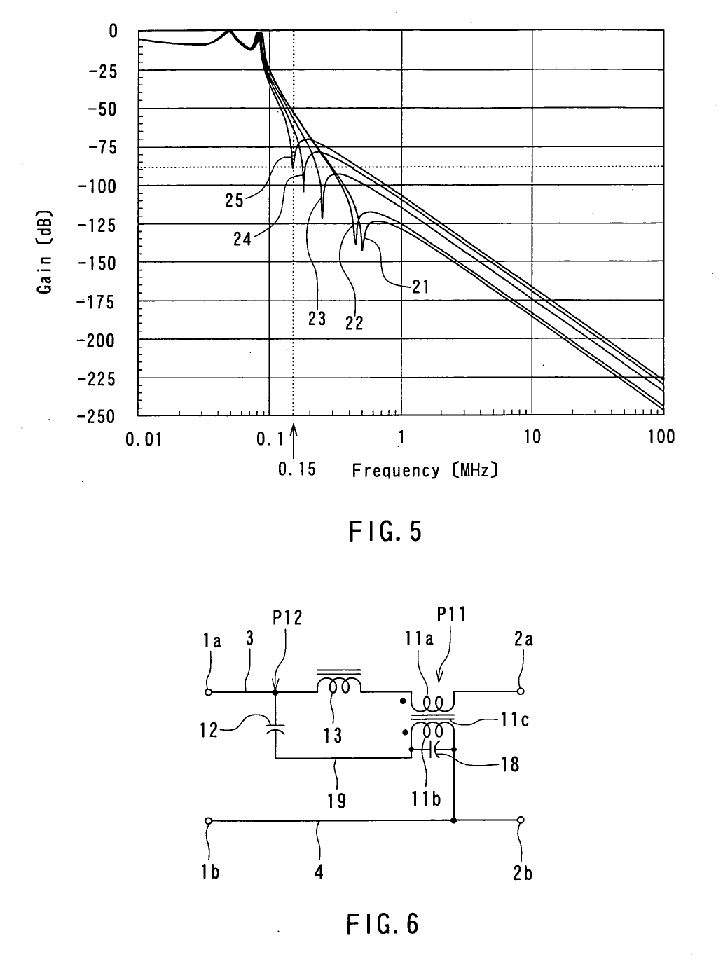

FIG. 5 is a plot showing frequency characteristics of attenuation of normal mode noise in the simulation circuit obtained by the simulation. In FIG. 5, the horizontal axis indicates frequencies and the vertical axis indicates gains. The smaller the gain, the greater is attenuation of noise. In FIG. 5, lines with numerals 21 to 25 indicate characteristics obtained when inductances of the winding 11b were 30 μH, 31 μH, 33 μH, 36 μH, and 38 μH, respectively.

As shown in FIG. 5, it is noted that, with regard to each of the characteristics indicated with numerals 22 to 25, the frequency at which attenuation is maximum is shifted to a lower frequency, compared with the characteristic indicated with numeral 21. Furthermore, if comparison is made among the characteristics indicated with numerals 22 to 25, it is noted that the frequency at which attenuation is maximum is reduced as the inductance of the winding 11b increases, that is, as the value obtained by dividing the number of turns of the winding 11b by that of the winding 11a increases.

As shown in FIG. 5, if comparison is made among amounts of attenuation at a frequency of 150 kHz in particular, it is noted that attenuation increases as the inductance of the winding 11b increases, that is, as the value obtained by dividing the number of turns of the winding 11b by that of the winding 11a increases. For example, for the characteristic indicated with numeral 25, the attenuation at a frequency of 150 kHz is greater than that of the characteristic indicated with numeral 21 by approximately 35 dB. In addition, for the characteristics indicated with numerals 24 and 25, the attenuation is greater than 60 dB in an entire frequency range of 150 kHz to 30 MHz. It is thereby possible to adapt the circuit to a variety of regulations.

The reason why it is preferable that the value obtained by dividing the number of turns of the winding 11b by that of the winding 11a (hereinafter called a turns ratio) be greater than 1 and smaller than or equal to 2.0 will now be described. As the result of the simulation shown in FIG. 5 indicates, the frequency at which the attenuation is maximum is shifted to a lower frequency by making the turns ratio greater than 1. In the result shown in FIG. 5, when the turns ratio is approximately 1.2 to 1.3, a favorable characteristic is obtained at a frequency of 150 kHz that is a lower limit of frequency range to be a target of a standard relating to noise. However, when the turns ratio is greater than 1, there occurs some slight degradation in the frequency characteristic of attenuation at frequencies higher than the frequency at which attenuation is maximum. The degree of such degradation increases as the turns ratio increases. Therefore, it is desirable to choose the turns ratio such that noise is effectively suppressed in a desired frequency range in accordance with the characteristic of noise in an environment where the noise suppressing circuit of the embodiment is used, and the turns ratio should not be of a value greater than is required. In view of the result shown in FIG. 5, it is considered that, as long as the turns ratio is greater than 1 and smaller than or equal to 2.0, it is possible to choose the turns ratio such that noise is effectively suppressed in a desired frequency range in accordance with the characteristic of noise.

As the result of the simulation shown in FIG. 5 indicates, according to the noise suppressing circuit of the embodiment, it is possible to suppress normal mode noise in a wide frequency range of 150 kHz to 30 MHz including a low frequency range of 150 kHz to 1 MHz.

According to the noise suppressing circuit of the embodiment, great attenuation of noise in a low frequency range of 1 MHz and lower is obtained through the use of the resonant characteristic. As a result, it is possible to effectively suppress normal mode noise in a low frequency range of 1 MHz and lower without using a coil having a high inductance. It is thereby possible to reduce the noise suppressing circuit in size, according to the embodiment.

### SECOND EMBODIMENT

FIG. 6 is a schematic diagram illustrating a configuration of a noise suppressing circuit of a second embodiment of the invention. The noise suppressing circuit of the second embodiment has such a configuration that the number of turns of the winding 11b is equal to that of the winding 11a, and a capacitor 18 provided in parallel to the winding 11b is added to the noise suppressing circuit of FIG. 1. The capacitor 18 has an end connected to an end of the winding 11b and has the other end connected to the other end of the winding 11b. The capacitor 18 corresponds to the second capacitor of the invention. In the second embodiment, the capacitor 12 corresponds to the first capacitor of the invention.

In the second embodiment, the capacitor 18 is provided in parallel to the winding 11b so as to obtain an effect similar to the effect obtained by making the number of turns of the winding 11b greater than that of the winding 11a as in the first embodiment. That is, according to the second embodiment, it is possible that the frequency at which attenuation of normal mode noise in the noise suppressing circuit is maximum is shifted to a lower frequency, compared with a case in which the capacitor 18 is not provided, and that the normal mode noise is effectively suppressed in a low frequency range of 1 MHz and lower, in particular.

In the second embodiment, it is preferred that a value obtained by dividing the capacitance of the capacitor 18 by that of the capacitor 12 fall within a range of 0.001 to 0.5 inclusive. The reason will be described later.

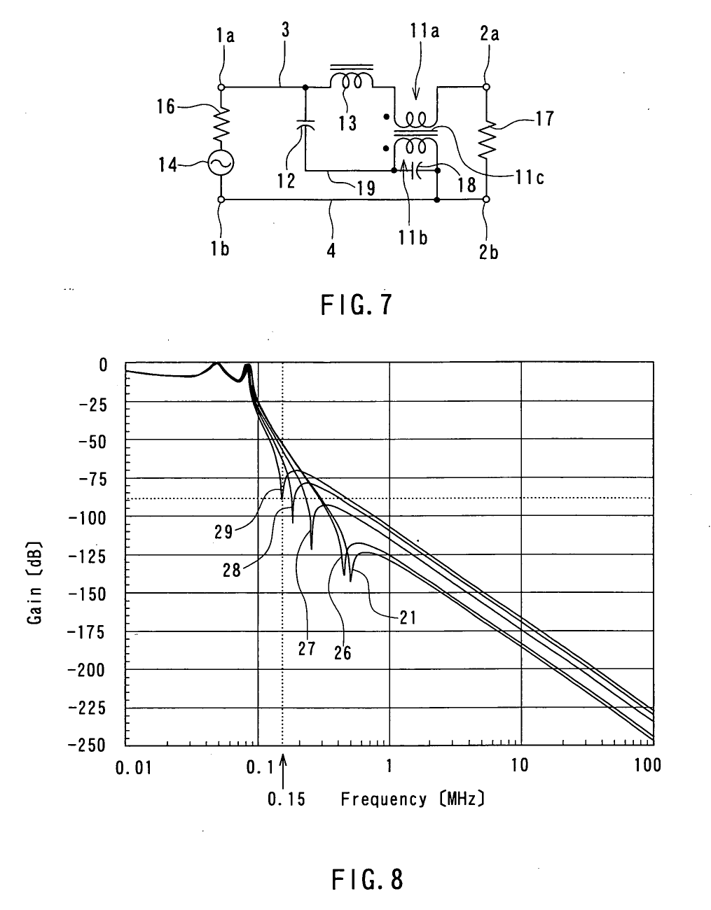

Effects of the noise suppressing circuit of the second embodiment will now be specifically described, using a result of a simulation shown below. FIG. 7 is a schematic diagram illustrating a configuration of a simulation circuit assumed in the simulation. The simulation circuit had a configuration in which a series circuit made up of the normal mode noise source 14 and the resistor 16 was connected between the terminals 1a and 1b of the noise suppressing circuit of FIG. 6, and the resistor 17 was connected between the terminals 2a and 2b. In the simulation, a circuit having a configuration in which the capacitor 18 was excluded from the circuit of FIG. 7 was also assumed.

Values that follow were used in the simulation. The inductance of the inductance element 13 of FIG. 7 was 30 μH. The inductance of each of the windings 11a and 11b was 30 μH. The capacitance of the capacitor 12 was 0.33 μF. The resistance of each of the resistors 16 and 17 was 50 ohms. The capacitance of the capacitor 18 was 0.001 μF, 0.01 μF, 0.022 μF, or 0.033 μF. In the simulation, the value obtained by dividing the capacitance of the capacitor 18 by that of the capacitor 12 falls within a range of 0.001 to 0.5 inclusive.

FIG. 8 is a plot showing frequency characteristics of attenuation of normal mode noise in the simulation circuit obtained by the simulation. In FIG. 8, the horizontal axis indicates frequencies and the vertical axis indicates gains. The smaller the gain, the greater is attenuation of noise. In FIG. 8, the line with numeral 21 indicates the characteristic of the circuit having a configuration in which the capacitor 18 is excluded from the circuit of FIG. 7. This characteristic is the same as the one indicated with numeral 21 in FIG. 5. In FIG. 8, lines with numerals 26 to 29 indicate characteristics obtained when the capacitances of the capacitor 18 were 0.001 μF, 0.01 μF, 0.022 μF, and 0.033 μF, respectively.

As shown in FIG. 8, it is noted that, with regard to each of the characteristics indicated with numerals 26 to 29, the frequency at which attenuation is maximum is shifted to a lower frequency, compared with the characteristic indicated with numeral 21. Furthermore, if comparison is made among the characteristics indicated with numerals 26 to 29, it is noted that the frequency at which attenuation is maximum is reduced as the capacitance of the capacitor 18 increases, that is, as the value obtained by dividing the capacitance of the capacitor 18 by that of the capacitor 12 increases.

As shown in FIG. 8, if comparison is made among amounts of attenuation at a frequency of 150 kHz in particular, it is noted that attenuation increases as the capacitance of the capacitor 18 increases, that is, as the value obtained by dividing the capacitance of the capacitor 18 by that of the capacitor 12 increases. For example, for the characteristic indicated with numeral 29, the attenuation at a frequency of 150 kHz is greater than that of the characteristic indicated with numeral 21 by approximately 35 dB. In addition, for the characteristics indicated with numerals 28 and 29, the attenuation is greater than 60 dB in an entire frequency range of 150 kHz to 30 MHz. It is thereby possible to adapt the circuit to a variety of regulations.

The reason why it is preferable that the value obtained by dividing the capacitance of the capacitor 18 by that of the capacitor 12 (hereinafter called a capacitance ratio) fall within a range of 0.001 to 0.5 inclusive will now be described. As the result of the simulation shown in FIG. 8 indicates, the frequency at which the attenuation is maximum is shifted to a lower frequency by providing the capacitor 18. In the result shown in FIG. 8, when the capacitance ratio is 0.1, a favorable characteristic is obtained at a frequency of 150 kHz that is a lower limit of frequency range to be a target of a standard relating to noise. However, when the capacitor 18 is provided, there occurs some slight degradation in the frequency characteristic of attenuation at frequencies higher than the frequency at which attenuation is maximum. The degree of such degradation increases as the capacitance ratio increases. Therefore, it is desirable to choose the capacitance ratio such that noise is effectively suppressed in a desired frequency range in accordance with the characteristic of noise in an environment where the noise suppressing circuit of the embodiment is used, and the capacitance ratio should not be of a value greater than is required. The result shown in FIG. 8 indicates that it is possible that, even when the capacitance ratio is 0.003, the frequency at which attenuation is maximum is shifted to a lower frequency as compared with the case in which the capacitor 18 is not provided. In view of the result shown in FIG. 8, it is considered that, as long as the capacitance ratio falls within a range of 0.001 to 0.5 inclusive, it is possible to choose the capacitance ratio such that noise is effectively suppressed in a desired frequency range in accordance with the characteristic of noise.

As the result of the simulation shown in FIG. 8 indicates, according to the noise suppressing circuit of the embodiment, it is possible to suppress normal mode noise in a wide frequency range of 150 kHz to 30 MHz including a low frequency range of 150 kHz to 1 MHz.

The remainder of configuration, operation and effects of the second embodiment are similar to those of the first embodiment.

### THIRD EMBODIMENT

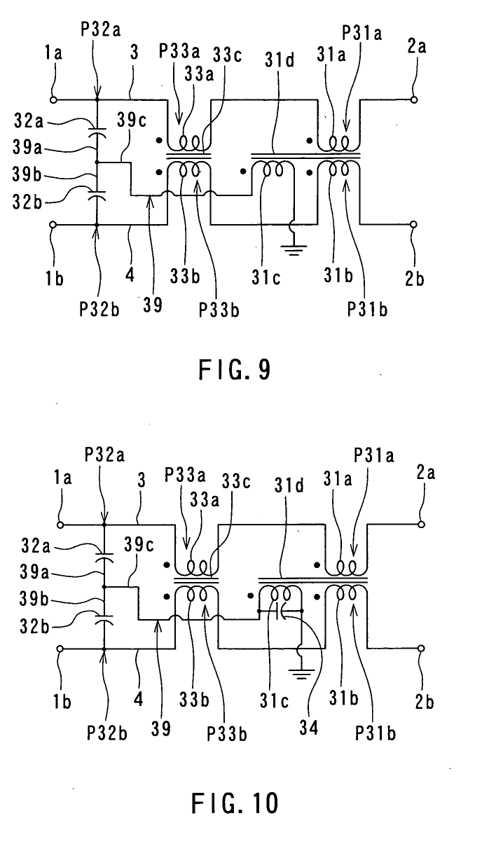

A noise suppressing circuit of a third embodiment of the invention will now be described. The noise suppressing circuit of the third embodiment is a circuit for suppressing common mode noise propagating through two conductor lines with identical phases. FIG. 9 is a schematic diagram illustrating the configuration of the noise suppressing circuit of the embodiment. The noise suppressing circuit comprises: a pair of terminals 1a and 1b; another pair of terminals 2a and 2b; the conductor line 3 connecting the terminal 1a to the terminal 2a; and the conductor line 4 connecting the terminal 1b to the terminal 2b. The noise suppressing circuit further comprises: a winding 31a inserted to the conductor line 3 at a specific first point P31a; a magnetic core 31d; a winding 31b that is inserted to the conductor line 4 at a point P31b corresponding to the point P31a and coupled to the winding 31a through the core 31d, and that suppresses common mode noise in cooperation with the winding 31a; and a winding 31c coupled to the windings 31a and 31b through the core 31d. The windings 31a and 31b and the core 31d make up a common mode choke coil. That is, the windings 31a and 31b are wound around the core 31d in such directions that, when magnetic fluxes are induced in the core 31d by currents flowing through the windings 31a and 31b when a normal mode current is fed to the windings 31a and 31b, these fluxes are cancelled out by each other. The windings 31a and 31b thereby suppress common mode noise and allow normal mode noise to pass.

The noise suppressing circuit further comprises an injection signal transmission path 39. An end of the injection signal transmission path 39 is branched and connected to the conductor lines 3 and 4. In the following description, a portion of the injection signal transmission path 39 from the branch point to the conductor line 3 is a transmission path 39a, a portion of the injection signal transmission path 39 from the branch point to the conductor line 4 is a transmission path 39b, and the remaining portion of the path 39 is a transmission path 39c. An end of the transmission path 39a opposite to the branch point is connected to the conductor line 3 at a point different from the first point P31a, that is, at a second point P32a between the winding 31a and the terminal 1a. An end of the transmission path 39b opposite to the branch point is connected to the conductor line 4 at a point P32b corresponding to the second point P32a. An end of the transmission path 39c opposite to the branch point is grounded.

The winding 31c is inserted somewhere along the transmission path 39c. Therefore, the injection signal transmission path 39 connects the winding 31c to the point P32a on the conductor line 3 and the point P32b on the conductor line 4 through a path different from the conductor lines 3 and 4. The injection signal transmission path 39 transmits injection signals, which will be described in detail later. The injection signals are generated based on signals corresponding to common mode noise detected on the conductor lines 3 and 4, and are injected to the conductor lines 3 and 4.

The noise suppressing circuit further comprises a capacitor 32a inserted somewhere along the transmission path 39a and a capacitor 32b inserted somewhere along the transmission path 39b. The capacitors 32a and 32b function as a high-pass filter that allow signals at frequencies equal to or higher than a specific value to pass.

The noise suppressing circuit further comprises: a winding 33a inserted to the conductor line 3 at a point P33a between the points P31a and P32a; a magnetic core 33c; and a winding 33b that is inserted to the conductor line 4 at a point P33b corresponding to the point P33a and coupled to the winding 33a through the core 33c, and that suppresses common mode noise in cooperation with the winding 33a. The windings 33a and 33b and the core 33c make up a common mode choke coil. That is, the windings 33a and 33b are wound around the core 33c in such directions that, when magnetic fluxes are induced in the core 33c by currents flowing through the windings 33a and 33b when a normal mode current is fed to the windings 33a and 33b, these fluxes are cancelled out by each other. The windings 33a and 33b thereby suppress common mode noise and allow normal mode noise to pass.

In the third embodiment, the number of turns of the winding 31a is equal to that of the winding 31b, and the number of turns of the winding 31c is greater than the number of turns of each of the windings 31a and 31b.

In the noise suppressing circuit of FIG. 9, the windings 31a, 31b and 31c, and the core 31d correspond to the detection/injection section 102 of FIG. 2. The windings 31a and 31b correspond to the first winding of the invention. The winding 31c corresponds to the second winding of the invention. The node between the transmission path 39a and the conductor line 3 and the node between the transmission path 39b and the conductor line 4 form the detection/injection section 103 of FIG. 2. The transmission path 39 corresponds to the transmission path 104 of FIG. 2. The common mode choke coil made up of the windings 33a and 33b and the core 33c corresponds to the peak value reducing section 105 of FIG. 2.

The operation of the noise suppressing circuit of FIG. 9 will now be described. First, a case in which a common mode noise source is located at a point closer to the points P32a, P32b than the points P31a, P31b except a point between the points P31a, P31b and the points P32a, P32b will be described. In this case, the capacitors 32a and 32b detect a signal corresponding to common mode noise at the points P32a and P32b on the conductor lines 3 and 4. Furthermore, based on the signal detected, the capacitors 32a and 32b generate an injection signal having a phase opposite to that of the common mode noise. The injection signal is supplied to the winding 31c through the injection signal transmission path 39. The winding 31c injects the injection signal to the conductor lines 3 and 4 through the windings 31a and 31b. As a result, common mode noise is suppressed along portions of the conductor lines 3 and 4 from the points P31a and P31b onward along the direction of travel of the common mode noise.

A case will now be described in which a noise source is located at a point closer to the points P31a, P31b than the points P32a, P32b except points between the points P31a, P31b and the points P32a, P32b in the cancellation-type noise suppressing circuit of FIG. 9. In this case, the winding 31c detects through the windings 31a and 31b a signal corresponding to common mode noise at the points P31a and P31b on the conductor lines 3 and 4. Furthermore, an injection signal is generated based on the signal detected. The injection signal is injected through the injection signal transmission path 39 and the capacitors 32a and 32b to the points P32a and P32b, such that the injection signal has a phase opposite to that of the common mode noise on the conductor lines 3 and 4. As a result, common mode noise is suppressed along portions of the conductor lines 3 and 4 from the points P32a and P32b onward along the direction of travel of the common mode noise. As thus described, the effect of suppressing noise of the noise suppressing circuit of FIG. 9 remains the same, regardless of the direction of travel of noise.

For the noise suppressing circuit of FIG. 9, if the operation relating to noise on the conductor line 3 and the operation relating to noise on the conductor line 4 are separately considered, the detailed description of the operation of the noise suppressing circuit of FIG. 3 equally applies to the noise suppressing circuit of FIG. 9.

In the noise suppressing circuit of FIG. 9, the common mode choke coil is inserted between the points P31a, P31b and the points P32a, P32b on the conductor lines 3 and 4. As a result, in this noise suppressing circuit, the difference is reduced between the peak value of the common mode noise propagating through the common mode choke coil and the peak value of the injection signal injected to the conductor lines 3 and 4 through the injection signal transmission path 39. It is thereby possible to effectively suppress common mode noise in a wide frequency range, according to the noise suppressing circuit.

In the third embodiment, like the first embodiment, the number of turns of the winding 31c is greater than the number of turns of each of the windings 31a and 31b, so that the frequency at which attenuation of common mode noise in the noise suppressing circuit is maximum is shifted to a lower frequency, compared with a case in which the number of turns of the winding 31c is equal to the number of turns of each of the windings 31a and 31b. As a result, it is possible to effectively suppress common mode noise in a low frequency range of 1 MHz and lower, in particular.

It is preferred that the value obtained by dividing the number of turns of the winding 31c by the number of turns of each of the windings 31a and 31b be greater than 1 and smaller than or equal to 2.0. The reason is the same as is described in the first embodiment.

It is possible that the resonant frequency ‘fo’ expressed by the equation (8) is shifted to a lower frequency by increasing the capacitance C1. However, it is inadvisable to increase the capacitances of the capacitors 32a and 32b in a noise suppressing circuit for suppressing common mode noise as the one shown in FIG. 9 since an increase in leakage current will result.

The remainder of configuration, operation and effects of the third embodiment are similar to those of the first embodiment.

### FOURTH EMBODIMENT

FIG. 10 is a schematic diagram illustrating a configuration of a noise suppressing circuit of a fourth embodiment of the invention. The noise suppressing circuit of the fourth embodiment has such a configuration that the number of turns of the winding 31c is equal to the number of turns of each of the windings 31a and 31b, and a capacitor 34 provided in parallel to the winding 31c is added to the noise suppressing circuit of FIG. 9. The capacitor 34 has an end connected to an end of the winding 31c and has the other end connected to the other end of the winding 31c. The capacitor 34 corresponds to the second capacitor of the invention. In the fourth embodiment, the capacitors 32a and 32b correspond to the first capacitor of the invention.

In the fourth embodiment, the capacitor 34 is provided in parallel to the winding 31c so as to obtain an effect similar to the effect obtained by making the number of turns of the winding 31c greater than the number of turns of each of the windings 31a and 31b as in the third embodiment. That is, according to the fourth embodiment, it is possible that the frequency at which attenuation of common mode noise in the noise suppressing circuit is maximum is shifted to a lower frequency, compared with a case in which the capacitor 34 is not provided, and that the common mode noise is effectively suppressed in a low frequency range of 1 MHz and lower, in particular.

In the fourth embodiment, it is preferred that the value obtained by dividing the capacitance of the capacitor 34 by the capacitance of each of the capacitors 32a and 32b fall within a range of 0.001 to 0.5 inclusive. The reason is the same as is described in the second embodiment.

The remainder of configuration, operation and effects of the fourth embodiment are similar to those of the third embodiment.

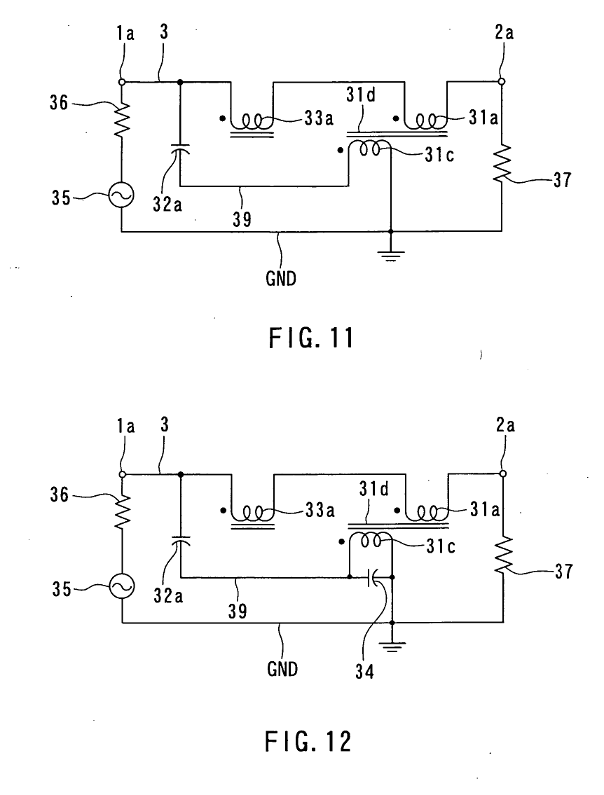

Effects of the noise suppressing circuits of the third and fourth embodiments will now be specifically described, using results of simulations shown below. FIG. 11 is a schematic diagram illustrating a configuration of a simulation circuit assumed in the simulation to correspond to the third embodiment. The simulation circuit is made up of only a portion of the noise suppressing circuit of FIG. 9 relating to suppression of signals passing through the conductor line 3. The simulation circuit of FIG. 11 comprises the terminals 1a and 2a, the conductor line 3 connecting the terminals 1a and 2a to each other, the winding 31a, the winding 31c, the magnetic core 31d, the capacitor 32a, and the winding 33a. The simulation circuit further comprises a common mode noise source 35, a resistor 36 and a resistor 37. The common mode noise source 35 has an end connected to an end of the resistor 36, and has the other end connected to a ground GND. The other end of the resistor 36 is connected to the terminal 1a. The resistor 37 has an end connected to the terminal 2a and the other end connected to the ground GND. In the simulation circuit, the number of turns of the winding 31c is equal to or greater than that of the winding 31a.

FIG. 12 is a schematic diagram illustrating a configuration of a simulation circuit assumed in the simulation to correspond to the fourth embodiment. This simulation circuit has such a configuration that the number of turns of the winding 31c is equal to that of the winding 31a, and the capacitor 34 provided in parallel to the winding 31c is added to the simulation circuit of FIG. 11.

Values that follow were used in the simulation. The inductance of each of the windings 31a and 33a of FIG. 11 and FIG. 12 was 2 mH. The resistance of each of the resistors 36 and 37 was 50 ohms. The capacitance of the capacitor 32a was 4400 pF. The inductance of the winding 31c of FIG. 11 was 2 mH or 2.4 mH. The case in which the inductance of the winding 31c was 2 mH corresponds to the case in which the number of turns of the winding 31c was equal to that of the winding 31a. The case in which the inductance of the winding 31c was 2.4 mH corresponds to the case in which the number of turns of the winding 31c was greater than that of the winding 31a. The inductance of the winding 31c of FIG. 12 was 2 mH. The capacitance of the capacitor 34 of FIG. 12 was 470 pF.

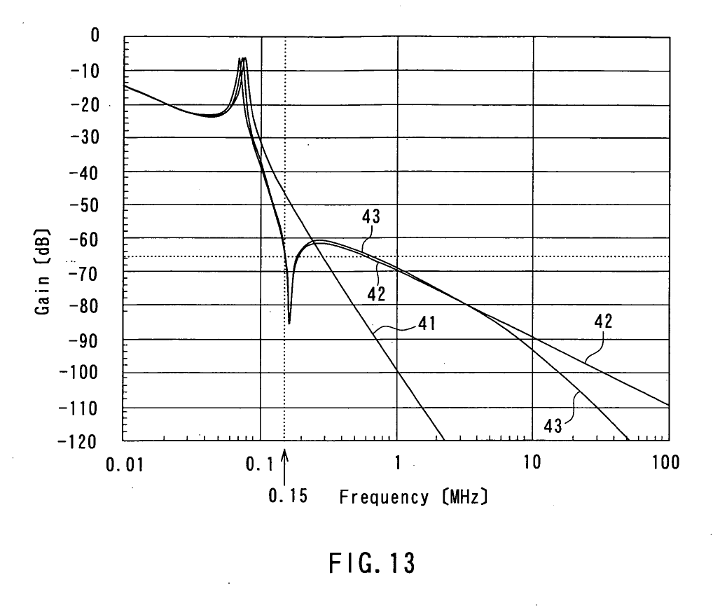

FIG. 13 is a plot showing frequency characteristics of attenuation of common mode noise in the simulation circuits obtained by the simulations. In FIG. 13, the horizontal axis indicates frequencies and the vertical axis indicates gains. The smaller the gain, the greater is attenuation of noise. In FIG. 13, the line with numeral 41 indicates the characteristic of the simulation circuit of FIG. 11 when the inductance of the winding 31c was 2 mH. The line with numeral 42 indicates the characteristic of the simulation circuit of FIG. 11 when the inductance of the winding 31c was 2.4 mH. The line with numeral 43 indicates the characteristic of the simulation circuit of FIG. 12.

As shown in FIG. 13, it is noted that, with regard to each of the characteristics indicated with numerals 42 and 43, the frequency at which attenuation is maximum is shifted to a lower frequency, compared with the characteristic indicated with numeral 41. The peak (the maximum frequency) of the characteristic indicated with numeral 41 exists outside the range shown in FIG. 13. The characteristics indicated with numerals 42 and 43 are nearly the same in a frequency range of approximately 150 kHz to 5 MHz. For each of the characteristics indicated with numerals 42 and 43, the attenuation at a frequency of 150 kHz is greater than that of the characteristic indicated with numeral 41 by approximately 20 dB. In addition, for the characteristics indicated with numerals 42 and 43, the attenuation is greater than 60 dB in an entire frequency range of 150 kHz to 30 MHz. It is thereby possible to adapt the circuit to a variety of regulations.

The foregoing description similarly applies to a portion of the noise suppressing circuit of each of the third and fourth embodiments of the invention shown in FIG. 9 and FIG. 10, respectively, the portion relating to suppression of signals passing through the conductor line 4.

The noise suppressing circuit of each of the foregoing embodiments is capable of being used as a means for reducing ripple voltage and noise emerging from a power transformer circuit or as a means for reducing noise on a power line in power-line communications and for preventing communications signals on an indoor power line from leaking to an outdoor power line.

The present invention is not limited to the foregoing embodiments but may be practiced in still other ways. For example, the second capacitor may be provided in parallel to the second winding while making the number of turns of the second winding greater than that of the first winding.

In the first and second embodiments, the winding 11a and the inductance element 13 are inserted to the conductor line 3 only. However, a winding and an inductance element similar to the winding 11a and the inductance element 13 may be inserted to the conductor line 4, in addition. In this case, a configuration as follows is possible. That is, components similar to the windings 11a and 11b, the core 11c and the inductance element 13 are additionally provided on the side of the conductor line 4. In addition, the injection signal transmission path 19 is provided to connect the point P12 on the conductor line 3 to a point on the conductor line 4 corresponding to the point P12. Furthermore, the winding 11b and a winding that is on the side of the conductor line 4 and that corresponds to the winding 11b are inserted in series to a point somewhere along the injection signal transmission path 19. In addition, the capacitor 12 is inserted somewhere along the injection signal transmission path 19.

As thus described, according to the noise suppressing circuit of the invention, it is possible to suppress noise in a wide frequency range and to reduce the noise suppressing circuit in size.

Obviously many modifications and variations of the present invention are possible in the light of the above teachings. It is therefore to be understood that within the scope of the appended claims the invention may be practiced otherwise than as specifically described.

1. A noise suppressing circuit for suppressing noise propagating through a conductor line, the noise suppressing circuit comprising:
a first winding inserted to the conductor line at a specific first point;
a second winding coupled to the first winding;
an injection signal transmission path that connects the second winding to a second point on the conductor line different from the first point through a path different from the conductor line and that transmits an injection signal generated based on a signal corresponding to noise detected on the conductor line and injected to the conductor line to suppress the noise; and
a capacitor inserted to the injection signal transmission path and allowing the injection signal to pass, wherein
the number of turns of the second winding is greater than the number of turns of the first winding.

2. A noise suppressing circuit according to claim 1, wherein a value obtained by dividing the number of turns of the second winding by the number of turns of the first winding is greater than 1 and smaller than or equal to 2.0.

3. A noise suppressing circuit according to claim 1, further comprising a peak value reducing section that is inserted to the conductor line at a point between the first and second points and that reduces a peak value of noise propagating through the conductor line.

4. A noise suppressing circuit according to claim 1, wherein:
the noise suppressing circuit is a circuit for suppressing normal mode noise that is transmitted through two conductor lines and that creates a potential difference between the two conductor lines; and
the first winding is inserted to at least one of the conductor lines.

5. A noise suppressing circuit according to claim 1, wherein:
the noise suppressing circuit is a circuit for suppressing common mode noise propagating through two conductor lines with identical phases;
the noise suppressing circuit further comprises another first winding and another capacitor;
the two first windings are inserted to the two conductor lines, respectively, to suppress common mode noise in cooperation with each other;
the second winding is coupled to the two first windings;
the injection signal transmission path is branched and connected to the two conductor lines; and
the two capacitors are inserted to the injection signal transmission path at respective points between a branch point of the injection signal transmission path and the respective conductor lines.

6. A noise suppressing circuit according to claim 1, wherein, with regard to a frequency characteristic of attenuation of noise, a frequency at which attenuation is maximum is 1 MHz or lower.

7. A noise suppressing circuit for suppressing noise propagating through a conductor line, the noise suppressing circuit comprising:
a first winding inserted to the conductor line at a specific first point;
a second winding coupled to the first winding;
an injection signal transmission path that connects the second winding to a second point on the conductor line different from the first point through a path different from the conductor line and that transmits an injection signal generated based on a signal corresponding to noise detected on the conductor line and injected to the conductor line to suppress the noise;
a first capacitor inserted to the injection signal transmission path and allowing the injection signal to pass, and
a second capacitor provided in parallel to the second winding.

8. A noise suppressing circuit according to claim 7, wherein a value obtained by dividing a capacitance of the second capacitor by a capacitance of the first capacitor falls within a range of 0.001 to 0.5 inclusive.

9. A noise suppressing circuit according to claim 7, further comprising a peak value reducing section that is inserted to the conductor line at a point between the first and second points and that reduces a peak value of the noise propagating through the conductor line.

10. A noise suppressing circuit according to claim 7, wherein:
the noise suppressing circuit is a circuit for suppressing normal mode noise that is transmitted through two conductor lines and that creates a potential difference between the two conductor lines; and
the first winding is inserted to at least one of the conductor lines.

11. A noise suppressing circuit according to claim 7, wherein:
the noise suppressing circuit is a circuit for suppressing common mode noise propagating through two conductor lines with identical phases;
the noise suppressing circuit further comprises another first winding and another first capacitor;
the two first windings are inserted to the two conductor lines, respectively, to suppress common mode noise in cooperation with each other;
the second winding is coupled to the two first windings;
the injection signal transmission path is branched and connected to the two conductor lines; and
the two first capacitors are inserted to the injection signal transmission path at respective points between a branch point of the injection signal transmission path and the respective conductor lines.

12. A noise suppressing circuit according to claim 7, wherein, with regard to a frequency characteristic of attenuation of noise, a frequency at which attenuation is maximum is 1 MHz or lower.
